(19) United States
(12) Patent Application Publication
(10) Pub. No.: US 2007/0107747 A1
(43) Pub. Date: May 17, 2007

(54) CLEANING PERCEPTION ORAL CARE PRODUCTS

(75) Inventors: Ira D. Hill, Austin, TX (US); Robert C. Lepple, Missouri City, TX (US); Dale G. Brown, Wharton, TX (US)

Correspondence Address: BANNER & WITCOFF, LTD., 28 STATE STREET, 28th FLOOR, BOSTON, MA, 02109-9601, US

(73) Assignee: Whitehill Oral Technologies, Inc., Stafford, TX (US)

(21) Appl. No.: 11/549,668

(22) Filed: Oct. 16, 2006

Related U.S. Application Data
(63) Continuation-in-part of application No. 11/349,042, filed on Feb. 7, 2006.
(63) Continuation-in-part of application No. 11/380,331, filed on Apr. 26, 2006.
(63) Continuation-in-part of application No. 10/005,902, filed on Dec. 4, 2001.
(63) Continuation-in-part of application No. 10/331,800, filed on Dec. 30, 2002.
(63) Continuation-in-part of application No. 11/118,911, filed on Apr. 29, 2005.
(63) Continuation-in-part of application No. 10/334,089, filed on Dec. 30, 2002, now Pat. No. 7,017,591.
(63) Continuation-in-part of application No. 11/549,671, filed on Oct. 16, 2006.
(63) Continuation-in-part of application No. 11/549,670, filed on Oct. 16, 2006.
(60) Provisional application No. 60/745,704, filed on Apr. 26, 2006.

(51) Int. Cl. A61C 15/00

(52) U.S. Cl. 132/321

(57) ABSTRACT

Various oral products coated with a saliva soluble coating containing: emulsions, film formers, and/or sialagogue and emulsion mixtures are post-treated with absorbable, stable, volatile flavors released from a reservoir under flavor-sealed conditions, such that, during use, a series of flavor signals are released from said oral products which collectively impart a clean perception.

### CROSS-REFERENCE TO RELATED APPLICATIONS

This application is a continuation-in-part of the following copending applications: U.S. patent application Ser. No. 11/349,042, filed Feb. 7, 2006 entitled: “Sialagogue Coatings for Interproximal Devices”; “Methods for Coating Dental Devices with Sialagogue Emulsions, Ser. No. 11/380,331, filed Apr. 26, 2006; Methods for Coating Dental Devices with Dry-to-the-Touch Saliva Soluble Flavors, Ser. No. 60/745,704, filed Apr. 26, 2006 (now abandoned); U.S. patent application Ser. No. 10/005,902, filed Dec. 4, 2001 entitled “Biofilm Therapy Process and Elements”; U.S. patent application Ser. No. 10/331,800, filed Dec. 30, 2002, entitled, “Coated Micromesh Dental Devices Overcoated with Imbedded Particulate”; U.S. patent application, Ser. No. 11/118,911, filed Apr. 29, 2005, entitled, “Coated Monofilament Oriented HDPE Dental Tapes”; and U.S. Pat. No. 7,017,591, entitled, “Particulate Coated Monofilament Devices”; U.S. patent application, Ser. No. 11/xxx,xxx, filed 16 Oct. 2006 (Attorney Docket No. 004526.00076), entitled, “Flavor-Stable Dental Devices; and U.S. patent application, Ser. No. 11/yyy,yyy, filed 16 Oct. 2006 (Attorney Docket No. 004526.00074), entitled, “Coated Dental Devices with Dry-to-the-Touch, Flavor-Absorbing, Saliva Soluble Coatings and Methods for Manufacturing”. The disclosures of these applications are hereby incorporated herein by reference.

### FIELD OF INVENTION

The field of the present invention relates to various oral products, including dental tapes, dental flosses, one-handed dental devices, which have been coated with volatile-flavor-adsorbing coatings, and oral care products which have been coated with saliva soluble coatings suitable for absorbing volatile flavors. These coated oral products are subsequently post-treated with absorbable volatile flavors such that, during use, a series of sequential hedonic signals are released, that synergistically impart a perception of cleaning. These clean perception oral products include a variety of medical devices suitable for cleaning spaces between teeth and below the gumline, including dental floss, dental tape, dental flossers, dental picks, dental massagers, proxy brushes, and the like, as well as consumable oral products, including: confectioneries, nutraceuticals, chewable medicaments, etc.

These oral products are coated with saliva soluble, film-forming substances, emulsions and the like. These saliva soluble film formers and emulsions can contain: (a) sialagogues, (b) sialagogues and surfactant mixtures, and/or (c) various biofilm-responsive substances containing sialagogues. The various coated dental devices that are post-treated with absorbable volatile flavors are suitable for physically: controlling, disrupting and removing biofilms, while delivering: sialagogues, biofilm-responsive coatings containing sialagogues, various active ingredients, etc., to interproximal surfaces. These clean perception dental devices not only remove, disrupt and control biofilms, but simultaneously increase and prolong saliva flow subgingivally and interproximally. All oral products of the invention, including dental devices and consumable oral products, impart a clean perception during use.

Specifically, the present invention relates to “clean perception” oral products, including disposable, dental devices coated with film formers and/or sialagogues and emulsions, which are subsequently post-treated with volatile flavors. These clean perception oral products include:

(1) Waxed dental devices such as described in U.S. Pat. Nos.: 174,619; 3,943,949; 2,700,636; 3,699,979; 3,744,499; 3,800,812; and 3,830,246

(2) Compression coated dental flosses and dental tapes including those described in U.S. Pat. Nos.: 4,911,927; 5,057,308; 5,057,309; 5,057,310; 5,098,711; 5,165,913; 5,538,667; 5,665,374; 5,711,935; 6,545,077; 6,575,176; 6,591,844; 6,604,534; 6,609,527; 6,907,889; 6,916,880; 7,017,591; and 7,025,986.

(3) Dental flossers as described in U.S. Pat. Nos.: 147,987; 175,795; 413,001; 2,217,917; 2,059,287; 2,784,722; 1,815,408; 2,187,899; 3,974,842; 3,926,201; 2,187,899; 2,443,415; 4,615,349; 3,974,842; 4,006,750; 4,016,892; 5,086,792; 5,538,023; 5,692,531; 3,858,594; 2,180,522; 2,187,899; 2,443,415; 3,926,201; 4,615,349; 1,415,762; 2,702,555; 2,811,162; 3,693,594; 4,192,330; 4,522,216; 4,807,651; 5,113,885; 5,123,432; 5,538,023; 5,503,168; 5,483,982; 5,388,600; 5,287,865; 5,246,021; 5,738,125; 5,704,379; 5,904,155; 5,829,458; 6,065,479; 6,227,210; and U.S. Patent Publication No. 2005-0205107 A1.
Additional examples of such devices are described in copending application Ser. No. 11/349,042, filed Feb. 7, 2006, now U.S. Patent Publication No. 2006-0177384 A1.

(4) Dental picks as described in U.S. Pat. Nos.: 4,651,760; 4,805,646; 5,234,009; 1,527,028; 2,008,206; 3,101,172; 3,910,293; 4,135,528; 4,271,854; 4,314,574; 4,403,625; 4,570,653; 4,577,649; 4,942,034; 2,667,443; 2,748,781; 2,772,205; 2,896,639; 3,838,702; 3,897,795; 4,029,113; 4,175,326; 4,462,136; 4,510,127; 4,627,975; 4,616,667; 5,234,009; 1,527,028; 2,008,206; 3,101,172; 3,910,293; 4,135,528; 4,271,854; 4,314,574; 4,403,625; 4,570,653; 4,577,649; 4,942,034; 2,667,443; 2,748,781; 2,772,205; 2,896,639; 3,838,702; 3,897,795; 4,029,113; 4,175,326; 4,462,136; 4,510,127; and 4,627,975.

(5) Proxy brushes as described in U.S. Pat. Nos.: D333,002; D360,077; D421,841; 5,027,467; 5,201,091; 5,309,596; 5,377,377; 5,633,083; 5,934,295; and 6,446,640, which are hereby incorporated by reference.
Additional examples of suitable other one-handed devices are described in co-pending patent application, Ser. No. 11/349,042, filed Feb. 7, 2006, now U.S. Patent Publication No. 2006-0177384 A1.

(6) Confectioneries as described in U.S. Pat. Nos.: 6,531,174; 5,879,728; 5,429,830; 5,626,896; 5,603,977; and 5,576,678.

(7) Nutraceuticals as described in U.S. Pat. Nos.: 6,949,264; 5,650,156; 6,835,372; 6,613,346; and 6,602,518.

(8) Chewable medicaments as described in U.S. Pat. Nos.: 6,103,260; 6,060,078; 5,846,557; and 5,494,681.

### BACKGROUND OF THE INVENTION

The introduction of “clean perception” properties to a wide range of oral products increases their frequency of use while simultaneously expanding the market potential for these oral products. Consumable clean perception products such as mints, nutraceuticals, chewable medicaments, etc., are particularly effective at introducing improved taste, mouthfeel and breath freshening to the oral cavity. Clean perception dental devices combine physical removal, disruption and control of biofilms with enhanced flavor, mouthfeel and breath freshening.

Of the various oral products of the invention, disposable, one-handed dental devices are preferred for conveniently delivering efficacy and clean perception to interproximal surfaces of the oral cavity. These include dental flossers, dental picks and proxy brushes, which require one hand to insert into interproximal areas. Additionally, these convenient, portable, one-handed, disposable dental devices can be carried in pocket or purse, and/or stored in desk drawers, glove compartments, etc., and therefore are accessible for use throughout the day, after meals, snacks, coffee breaks, etc. . . . when the user can't brush, but should.

Because of the injection molding process used to manufacture dental flossers, the flossing substrates on the flossers cannot be coated with substantial quantities of saliva soluble substances that can be released during flossing into the mouth such as described in the various U.S. Pat. Nos. issued to Hill, et al. referenced above under compression coated dental flosses and dental tapes.

Specifically, the floss or dental tape substrate in flossers cannot be similarly coated prior to injection molding due to the high temperatures encountered in the injection molding process used to capture the floss or tape in flossers. These high temperatures will not accommodate most coated floss substrates. Accordingly, disposable dental flossers generally are unflavored and deliver very little, if any, coating substances into interproximal areas during flossing.

Heretofore, most disposable flossers have had limited opportunity to introduce flavors, mouth feel agents, tingling substances, volatile top notes, etc., into the oral cavity during use. Certain flossers have been provided with post-added zones of flavor, etc., such as described in U.S. Pat. Publication No. 2006-0042650. To date, no disposable, one-handed, dental devices have been able to deliver tingling sensation, mouthfeel and/or volatile top notes to the oral cavity during use. Attempts to post-coat dental flossers and dental picks via dipping, spraying, etc., have generally been unsuccessful. Most post-coated devices have been unsightly and consumer unfriendly, indicating substantial flaking of the coating prior to use.

It is generally agreed that oral products, including confectioneries, nutraceuticals, chewable medicaments, dental flosses, dental tapes, dental flossers, dental picks, proxy brushes and other one-handed, disposable dental devices could be improved substantially if they were coated with tingling substances contained in a saliva soluble emulsions and post-treated with volatile flavors that could be released during use.

### OBJECTS OF THE INVENTION

An object of the present invention is to coat various oral products with saliva soluble substances that absorb volatile flavors, followed by post-treating these coasted oral products with volatile flavors, which can be released during use to create a perception of cleaning.

A further object of the invention is to coat oral products with multiple coatings of: emulsions, saliva soluble sialagogues and emulsion mixtures, and/or film formers, followed by post-treating with adsorbable volatile flavors that collectively impart a cleaning perception to coated oral products during use.

Still another object of the invention is to adapt commercial confectionery equipment and processes to coating various oral products with multiple coatings of: emulsions, sialagogue and emulsion mixtures, and/or film formers, followed by commercial post-treating with volatile flavors under flavor-sealed conditions that promote absorption of said flavors by said coatings while maintaining the volatile flavors free from degradation.

Yet another object of the invention is to coat oral products with saliva soluble: emulsions, sialagogue/MICRODENT® emulsions, waxes and/or film formers, followed by post-treatment with volatile flavors.

These and other objects of the invention are achievable and understandable by one skilled in the art after reviewing the specification, examples and claims set out below.

### SUMMARY OF THE INVENTION

The present invention is directed to compositions of matter and methods for imparting a cleaning perception to a wide range of coated oral products.

For one-handed devices, confectioneries, etc., a suitable coating method comprises: imparting tumbling motion to these oral products by means of a rotating drum-type means and simultaneously periodically introducing into the drum a sialagogue emulsion/film-forming mixture, accompanied by controlled heat and air flow; thereby coating these oral products in their entirety with multiple saliva soluble coatings of sialagogue and emulsion mixtures, and film-forming mixtures, followed by drying each coating with heat and air prior to applying a subsequent coating, followed by drying with heat and air. Said multiple coatings comprise from between about 0.25% and about 6% by weight of these multi-coated oral products. These are post-treated with volatile flavors under flavor-sealed conditions.

For certain dental flosses and dental tapes, the emulsions, emulsions and sialagogue mixtures, and/or film-forming coatings are applied using compression coating methods. For other wax-coated dental flosses and dental tapes and coated tapes and flosses, traditional coating techniques are used. These various coated dental devices are subsequently post-treated with volatile flavors from a flavor reservoir to impart a clean perception during use. Preferably, the flavor reservoir is selected from the group consisting of absorbent paper, absorbent polymers, alcoholic solutions, and combinations thereof containing a flavor.

Various saliva soluble, coated oral products as described above are further enhanced with a sequential series of hedonic signals that unexpectedly impart a perception of cleaning, wherein:

(a) said saliva soluble, coatings suitable for absorbing volatile flavor top notes are selected from the group consisting of emulsions, sialagogue and polydimethylsiloxane emulsion mixtures, waxes, various hydroxy alkyl cellulose film formers, emulsion and sialagogue combinations, diglycerol, polyphosphates, film-forming substances, dry-to-the-touch substances, and combinations thereof;

(b) sources for said sequential series of hedonic signals are selected from the group consisting of: volatile flavor top notes, absorbed volatile flavor top notes, emulsion/sialagogue combinations, and combinations thereof;

(c) said saliva soluble, coated oral products are contained under flavor-sealed conditions with a flavor reservoir of volatile top notes, which top notes are protected from degradation and/or fractionation, while under flavor seal; and

(d) said saliva soluble, coated oral products absorb volatile flavor top notes while contained with a flavor reservoir under flavor-sealed conditions.

The Clean Perception invention relies on a series of hedonic signals to create a perception of cleaning, which is totally unexpected while adding a most relevant product benefit to the oral products of the invention.

Specifically:

1. When the “special” flavor-sealed package is opened, clean, fresh, volatile top notes are released;

2. When the oral product is removed from the package and placed in the mouth, these volatile top notes register a “clean perception”. These effects are available across a wide range of flavor types, including citrus and mint characters, which have not been available heretofore in oral products. These are the clean perception segments of flavors that heretofore have been lost in all efforts to produce high-flavor impact dental flosses, dental tapes, other dental devices, confectioneries, nutraceuticals and other consumable oral products. The registration with the consumer of these flavor segments “preconditions” the consumer's perception that the oral product is going to clean the mouth, gums and especially the breath;

3. Approximately 30 seconds after the oral product is placed in the mouth, the sialagogues present in the saliva soluble coating “kick-in” creating the sensation of foam or bubbles breaking, which is commonly associated with cleaning. Had the sialagogues been presented to the oral cavity without the other cleaning perception factors, such as the emulsion, the perception would be primarily described as “tingling”, but in this environment, the sialagogues surprisingly contribute to an overall bubbles-breaking/clean perception; and

4. Finally, when the oral product is used up, the MICRODENT® or other emulsion or film-forming agent in the saliva soluble coating that has been released during use, coats the oral cavity, creating a slick, clean, lasting perception, generally associated with a “just-brushed” feeling.

The hedonic signals described above add a new dimension to the price/value of Clean Perception Oral Products.

Thus, one aspect of the present invention is directed to oral products with saliva soluble coatings containing flavor absorbing coating substances selected from the group consisting of film-forming substances, emulsions, sialagogue-containing emulsions of surfactant and polydimethylsiloxane, waxes, diglycerol, polyphosphate, sialagogues, hydroxylalkylcellulose film formers and combinations thereof.

Preferably, the oral products are flavor-sealed under conditions wherein volatile flavors remain stable, and said oral products are selected from the group consisting of: interproximal dental devices, confectioneries, nutraceuticals, chewable medicaments and combinations thereof. Preferably, the interproximal devices are selected from the group consisting of: dental flosses, dental tapes, dental flossers, dental picks, dental stimulators, proxy brushes and combinations thereof. Preferably, the confectioneries are selected from the group consisting of: mints, lozenges, dragee coated chewing gums, dragee coated bubble gums, and combinations thereof. Preferably, the absorbable volatile flavors are supplied by a reservoir in a flavor-sealed environment provided with an inert volatile flavor stabilizing gas. Preferably, the flavor reservoir is selected from the group consisting of absorbent paper, absorbent polymers, alcoholic solutions, and combinations thereof containing a flavor.

Another aspect of the present invention is directed to oral products having at least one saliva soluble coatings containing a flavor adsorbing substance are post-treated with absorbable, stable, volatile flavors, under flavor-sealed conditions, that promote absorption of said volatile flavors, such that during use said oral products release flavor signals imparting a cleaning perception.

Another aspect of the present invention is directed to a method for coating oral products with multiple coatings of saliva soluble emulsions and sialagogues, comprising:
(a) introducing said oral products into a moving coating drum that imparts tumbling motion to said oral products,
(b) introducing, periodically into a drum, said emulsions and sialagogues,
(c) coating said moving oral products with coatings of said sialagogues and emulsions,
(d) removing substantially all the moisture between coatings, and
(e) discharging said coated oral products from said coating drum, at such time as said coating comprises from between about 0.25 and about 6% by weight of said coated oral products.

Preferably, the emulsion contains a surfactant selected from the group consisting of solid and liquid surfactants and mixtures thereof. Preferably, the emulsion contains a polydimethylsiloxane. Alternatively or additionally, the emulsion contains a film former. Preferably, the oral products are selected from the group of one-handed dental devices consisting of dental flossers, dental picks, proxy brushes and combinations thereof. Preferably, the coatings are selected from the group consisting of film-forming substances; emulsions; sialagogue-containing surfactant polydimethylsiloxane emulsions; saliva soluble sialagogue coatings; saliva soluble, sialagogue, crystal-free coatings; waxes; diglycerol polyphosphates; hydroxyalkyl cellulose film formers; and mixtures thereof. Alternatively or additionally, the coatings contain additional adjuvants selected from the group consisting of sweetening agents, stabilizers, buffering ingredients, SOFT ABRASIVES®, chemotherapeutic ingredients, crystal formation eliminating additives, flavoring agents, colorants, and mixtures thereof.

Preferably, the sialagogue in the saliva soluble emulsion and sialagogue mixture is selected from the group consisting of gustatory sialagogues, pharmaceutical sialagogues, and mixtures thereof. More preferably, the sialagogue is selected from the group consisting of: plant extracts, Jamba Oleorisin/Spilanthol mixture, Spilanthes, Heliopsis longipes, and mixtures thereof. Preferably, the surfactants in said emulsions are selected from the group of liquid and solid surfactants consisting of: polyoxyethylene glycol sorbitan mono- and di-aliphatic esters represented by the general formula: 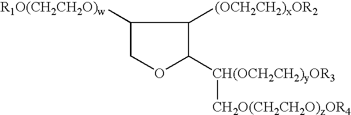
wherein R₁, R₂, R₃, R₄ and H or aliphatic acyl groups having from between about 10 and 30 carbon atoms, and the sum of w, x, y, and z is from between about 20 and about 80,

sodium lauryl sulfate,

sodium lauryl sarcosinate,

polyethylene glycol stearate,

polyethylene glycol monostearate,

coconut monoglyceride sulfonates,

sodium alkyl sulfate,

sodium alkyl sulfoacetates,

block copolymers of polyoxyethylene and polyoxybutylene,

allylpolyglycol ether carboxylates,

polyethylene derivatives of sorbitan esters,

propoxylated cetyl alcohol,

block copolymers comprising a cogeneric mixtures of conjugated

polyoxypropylene, and polyoxyethylene compound having as a hydrophobe a

polyoxypropylene polymer of at least 1200 molecular weight as Poloxamer 407

and Poloxamer 388,

soap powder, and

mixtures thereof.

Another aspect of the present invention is directed to an apparatus useful for coating oral products with multiple saliva soluble coatings that includes: (a) a coating drum arrangement, which preferably rotates around an axis, while keeping oral products introduced into said drum in motion, (b) a means for periodically introducing a coating emulsion into said drum at a controllable rate, and (c) controllable heat and air flow means for removing moisture from coated oral products as they are tumbled in said coating drum.

Yet another aspect of the present invention is directed to a method for coating oral products with emulsions comprising: introducing said oral products into a coating vessel that imparts motion to said products, periodically introducing said emulsions into said coating vessel, and removing moisture from said vessel between coating applications with the introduction of controllable heat and air flow.

Another aspect of the present invention is directed to emulsion and sialagogue coated oral products produced by adapting confectionery coating processes, including:

(a) introducing said oral products into a moving coating drum that imparts tumbling motion to said dental devices,

(b) introducing, periodically into said drum, said emulsion and sialagogue,

(c) coating said moving oral products with multiple coatings of said sialagogue and emulsion mixture,

(d) removing substantially all the moisture between coatings, and

(e) discharging said coated oral products from said coating drum, at such time as said coating comprises from between about 0.25 and about 6% by weight of said coated oral products.

Yet another aspect of the present invention is directed to a method for coating disposable, one-handed dental devices with multiple coatings of saliva soluble, emulsions selected from the group of adapted methods for coating confectioneries consisting of pan coating, fluidized bed, wurster machine coating, dragee kettle coating, dragee perforated pan coating, and combinations thereof.

### DEFINITIONS

For purposes of describing the present invention, the following terms, as used throughout this specification, are defined as set out below:

“Oral products” of the invention are defined as:
(1) dry-to-the-touch: confectioneries, nutraceuticals, chewable medicaments and dental devices, including one-handed devices such as dental flossers, dental picks, dental massagers, proxy brushes, etc., coated with multiple coatings of: emulsions, sialagogue and emulsion mixtures and/or film formers, all of which absorb volatile flavors and are post-treated with absorbable volatile flavors that release a series of hedonic signals that impart a perception of cleaning during use;
(2) coated flosses and dental tapes having wax or other substances coated thereon, which are suitable for absorbing volatile flavors. See U.S. Pat. Nos.: 174,619; 3,943,949; 2,700,636; 3,699,979; 3,744,499; 3,800,812 and 3,830,246.
(3) compression coated dental floss and dental tape dispensed in flavor-sealed packaging, where the compression coating contains sialagogue emulsions and the unit-dose packaging contains a stabilized, volatile-flavor reservoir that, in combination, impart a clean perception during use. See U.S. Pat. Nos.:
4,911,927; 5,057,308; 5,057,309; 5,057,310; 5,098,711; 5,165,913; 5,538,667; 5,665,374; 5,711,935; 6,545,077; 6,575,176; 6,591,844; 6,604,534; 6,609,527; 6,907,889; 6,916,880; 7,017,591; and 7,025,986.
(4) “Confectioneries, nutraceuticals and chewable medicaments” of the invention are described in the following U.S. Pat. Nos.: 6,531,174; 5,879,728; 5,429,830; 5,626,896; 5,603,977; 5,576,678; 6,949,264; 5,650,156; 6,835,372; 6,613,346; 6,602,518; 6,103,260; 6,060,078; 5,846,557; and 5,494,681.
(5) “Disposable one-handed dental devices” of the invention are defined as medical devices treated with multiple coatings of a saliva soluble coating containing an emulsion and/or a sialagogue and emulsion mixture, and/or a film-forming substance, which are subsequently treated with and absorbable volatile flavors. These devices are suitable for physically controlling, disrupting and removing biofilms, while releasing the saliva soluble coatings with absorbed volatile flavors that impart a cleaning perception while simultaneously increasing and prolonging saliva flow. Disposable, one-handed dental devices of the invention include: dental flossers, proxy brushes, dental stimulators, dental massagers, dental picks, etc., including:
A. Disposable, one-handed dental flossers such as described below:
   For more than one hundred years there have been attempts to improve and modernize the dental flossing technique by development of holders onto which floss is detachably or permanently secured, and a few hundred patents have already been granted on various flossing devices. These go back to the Shurtleft U.S. Pat. No. 147,987 of 1874, and Wallace U.S. Pat. No. 175,795 of 1876. In general, the dental flossers of the prior art have fallen into two basic categories, namely the reusable or permanent dental flossers wherein the customer threads the device with floss and then throws away the floss after use, but retains the flosser; and the disposable dental flossers having a structure to which the floss is permanently attached, the entire device being thrown away after one or more uses and replaced by another similar device.
   In general, the dental flossers of the permanent type are, as would naturally be expected, of considerably more complex construction and made of more expensive materials. Examples of such devices are those shown in the patents to Munroe U.S. Pat. No. 2,217,917; Storm U.S. Pat. No. 2,059,287; Chamberlin et al. U.S. Pat. No. 2,784,722; and Jordan U.S. Pat. No. 1,815,408.
   Disposable, one-handed flossers, such as contemplated by the present invention, have to be made inexpensively and the floss has to be permanently attached to the flosser in some way. Examples of patents disclosing disposable flossers are the Chodorow U.S. Pat. No. 3,974,842; Katz U.S. Pat. No. 3,926,201; and Henne U.S. Pat. No. 2,187,899. Buscarino U.S. Pat. No. 2,443,415 shows both disposable and permanent flossers. A major problem with disposable flossers of the prior art is the inadequate means of attachment of the floss, because in all cases the prior art requires either complex and expensive, or insufficient means of attachment. Thus, the Chodorow and Katz patents require that the flosser be molded about the floss, which is extremely expensive. Knotting has also been suggested, but this also is expensive and in some cases inadequate. Henne U.S. Pat. No. 2,187,899 suggests various types of mechanical attachment, but none of these provide adequate anchoring; often when floss is forced between two adjacent teeth and the spacing is small, tremendous tensile force is applied and mechanical attachments of this type are not adequate, the floss ends merely pulling from their mechanical anchoring means.
   With regard to the molding of the flosser about the ends of the floss, such as shown in the Chodorow and Katz patents, this produces not only a very expensive product, but also limits the types of floss which can be used. For example, medicated and flavored flosses, wherein the medicaments and flavorings are heat sensitive or volatile, cannot be used in the hot molding process because the heat of the operation and the molten plastic will degrade and/or drive off the medicament and/or flavoring material. Further, the medicaments and flavorings negatively impact the strength of the hot molded plastic as well as the polymer's ability to firmly affix the floss into the flosser device. See U.S. Pat. Publication No. 2005-0205107 A1 and also the following U.S. Pat. Nos.:
4,615,349, 3,974,842; 4,006,750; 4,016,892; 5,086,792; 5,538,023; 5,692,531; 3,858,594; 2,180,522; 2,187,899; 2,443,415; 3,926,201; 4,615,349; 413,00 1; 1,415,762; 2,702,555; 2,811,162; 3,693,594; 4,192,330; 4,522,216; 4,807,65 1; 5,113,885; 5,123,432; 147,987; 175,795; 413,001; 2,217,917; 2,059,287; 2,784,722; 1,815,408; 2,187,899; 3,926,201; 2,187,899; 2,443,415; 3,974,842; 5,538,023; 5,503,168; 5,483,982; 5,388,600; 5,287,865; 5,246,02 1; 5,73 8,125; 5,704,379; 5,904,155; 5,829,458; 6,065,479; and 6,227,210.
   Additional examples of such devices are described in copending application Ser. No. 11/349,042, filed Feb. 7, 2006, now U.S. Pat. Publication No. 2006-0177384 A1.
   All of the foregoing dental flosser references are incorporated herein by reference.
B. Disposable dental picks of the invention such as described below:
   In U.S. Pat. No. 4,651,760, a toothpick made from plastic is disclosed which has a pointed end supported by a mid portion having longitudinal notches which allows the toothpick to be compressed in a transverse direction and also has transverse flaps which may strike the tooth surfaces. A projecting plate is used as a handle. The flaps also insure that the toothpick attains considerable rigidity to keep its shape even though it may be subject to twisting.
   In U.S. Pat. No. 4,805,646, a toothpick is disclosed which has a tapered triangular point which extends from a flexing joint which allows the point to assume various different angles. However, the tip itself if fairly rigid.
   U.S. Pat. No. 4,616,667 discloses another toothpick design which has two ends which are pointed, having a shaft, a preferably substantially rectangular transverse cross-section and a longitudinally grooved cleaning tip which permits deformation of the tip in such a manner and direction to reach in between the narrow gaps of teeth while not sacrificing the longitudinal rigidity of the cleaning tip. Consequently, the area adjacent the tip may be bent but the tip itself remains rigid. See also U.S. Pat. Nos.:
5,234,009; 1,527,028; 2,008,206; 3,101,172; 3,910,293; 4,135,528; 4,271,854; 4,314,574; 4,403,625; 4,570,653; 4,577,649; 4,942,034; 2,667,443; 2,748,781; 2,772,205; 2,896,639; 3,838,702; 3,897,795; 4,029,113; 4,175,326; 4,462,136; 4,510,127; 4,627,975; 4,651,760; 4,805,646; 5,234,009; 1,527,028; 2,008,206; 3,101,172; 3,910,293; 4,135,528; 4,271,854; 4,314,574; 4,403,625; 4,570,653; 4,577,649; 4,942,034; 2,667,443; 2,748,781; 2,772,205; 2,896,639; 3,838,702; 3,897,795; 4,029,113; 4,175,326; 4,462,136; 4,510,127; 4,627,975; 4,616,667; 4,135,528; 4,271,854; 4,314,574; 4,403,625; and 4,570,653.
   See also the discussion of wooden toothpicks by Diamond Brands at their website, www.diamondbrands.com. Commercial dental picks suitable for the purposes of the present invention include: STIM-U-DENTS®, Jordan Stimulators and Placontrol Picks.
   All of the foregoing dental pick references are incorporated herein by reference.
C. “Disposable proxy brushes” of the invention are defined as medical devices such as described in U.S. Pat. Nos.: D333,002; D360,077; D421,841; 5,027,467; 5,201,091; 5,309,596;

5,377,377; 5,633,083; 5,934,295; and 6,446,640, which are hereby incorporated by reference.

Additional examples of suitable other disposable one-handed devices are described in co-pending patent application, Ser. No. 11/349,042, filed Feb. 7, 2006, now U.S. Pat. Publication No. 2006-0177384 A1.

“Dry-to-the-touch, multicoated oral products” of the present invention are defined as saliva soluble, sialagogue emulsion coated oral products, wherein the emulsion contains surfactants and/or dry film-forming ingredients that absorb post-added volatile flavors. These dry-to-the-touch, multicoated oral products release sequential hedonic signals during use which impart a perception of cleaning.

As used herein, the term “Flavor reservoir” refers to various sources for volatile flavor top notes, where the flavor reservoir is contained in a flavor-sealed environment under conditions that obviate top note degradation such as purging the sealed environment with an inert gas such as nitrogen prior to addition of the reservoir and flavor sealing the environment.

“Dry-to-the-touch, multiple coatings” suitable for coating certain oral products of the invention, including confectioneries, nutraceuticals, chewable medicaments and one-handed dental devices, are defined as those compositions which, in spite of high levels of flavor oils, surfactants, waxy emulsions and active ingredients, are by reason of their formulation with dry-film forming agents, surprisingly rendered dry-to-the-touch without reducing their saliva-soluble properties or limiting their ability to deliver consumer-preferred properties when used in the oral cavity.

“Wax emulsions” suitable for multiple coatings of the dry-to-the-touch oral products of the invention are defined to include: (a) various water-soluble waxes such as PEG, alone or with a flavor solubilizing surfactant, (b) Lipowax (mixtures of fatty acid PEG surfactant, a long chain alcohol), and (c) emulsifying waxes.

“Saliva soluble coatings” suitable for the oral products of the invention are defined as those saliva soluble substances containing sialagogue that coat oral products for purposes of: flavor and mouthfeel enhancement, lubrication and ease of device insertion interproximally and for delivering interproximally, cleaners, therapeutic antimicrobials, flavors, sialagogues and other additives. These saliva soluble coatings generally comprise from between about 0.25% to about 6% by weight of the dry-to-the-touch oral products and from 25 to over 100% by weight of the dental flosses and dental tapes of the invention.

Preferred saliva soluble coatings which can contain sialagogues include:

(a) those emulsion coatings described in the following U.S. Pat. Nos. 4,950,479; 5,032,387; 5,538,667; 5,561,959; and 5,665,374, which are hereby incorporated by reference,

(b) various dental device coatings, such as described in U.S. Pat. Nos. 5,908,039; 6,080,495; 4,029,113; 2,667,443; 3,943,949; 6,026,829; 5,967,155 and 5,967,153, which are hereby incorporated by reference,

(c) those substantive saliva soluble coatings described and claimed in U.S. Pat. Nos. 6,907,889; 6,609,527; 6,916,880 and 6,545,077, which are hereby incorporated by reference, and

(d) those coatings described in copending applications: Ser. No. 11/096,606, filed Apr. 1, 2005, entitled: “Coated Monofilament Tape Bobbins and Methods for Winding,” now U.S. Pat. Publication No. 2005-0199334 A1; Ser. No. 11/149,597, filed Jun. 10, 2005, entitled: “Non-Crystalline Saliva-Soluble Coatings for Elastomeric Monofilament Dental Tapes,” now U.S. Pat. Publication No. 2005-0226820 A1; and Ser. No. 11/196,827, filed Aug. 3, 2005, entitled: “Biofilm Therapy Interproximal Devices,” now U.S. Pat. Publication No. 2006-0034782 A1.

All of the foregoing saliva soluble coatings can contain biofilm-responsive levels of one or more substances suitable for controlling and disrupting biofilms and at least one sialagogue for prolonging and increasing saliva flow, while also functioning as the absorbing surface for volatile flavors post-added to the oral products of the invention.

As used herein, “coating” is generally defined as the process of introducing sialagogues emulsions, as well as other oral care substances onto the surfaces of various oral products of the invention.

As used herein, the terms “MICRODENT®” and “ULTRAMULSION®” refer emulsions of polydimethylsiloxane at various molecular weights in various poloxamer surfactants as described and claimed in U.S. Pat. Nos. 4,911,927; 4,950,479; 5,032,387; 5,098,711; 5,165,913; 5,538,667; 5,645,841; 5,651,959 and 5,665,374. In addition to coating consumable oral products of the invention, these emulsions are preferably included in crystal-free sialagogue emulsion coatings of various disposable, one-handed dental devices of the invention.

As used herein, the phrase “saliva-soluble, crystal-free coatings” refers to those sialagogue-containing emulsions used in compression coating of dental floss and dental tape that indicate substantial flake resistance, yet release from various dental flosses and tape of the present invention during use when exposed to saliva in the oral cavity. These coatings can include SOFT ABRASIVES® that are dispersed and not solubilized in said coatings. These SOFT ABRASIVES® remain insoluble when delivered between teeth and below the gum line during use. Additionally, saliva-soluble, crystal-free coatings preferably contain surfactants, mouth conditioners, chemotherapeutic ingredients and flavors that are released from the dental flosses and tapes into the oral cavity, along with at least one sialagogue. For example, see U.S. Pat. Nos. 6,609,527 and 6,575,176.

As used herein, the term “crystal-free” refers to a smooth surface on the dental flosses and dental tapes of the invention as distinguished from rough surfaces typical of crystalline coatings when observed through a 30× stereo zoom microscope. See U.S. Pat. No. 6,609,527. Generally, crystal-free coatings containing sialagogues indicate minimum flaking. Examples of suitable crystal-free, sialagogue-containing coating formulations for various dental flosses and dental tapes of the invention are detailed in the Examples and Tables below.

As used herein, the term “biofilm therapy disposable, clean perception, dental devices” are defined as dental devices coated with sialagogues, sialagogue emulsions, and saliva soluble coatings containing sialagogues; that adsorb volatile flavors from a flavor reservoir contained under flavor-sealed conditions. These devices control, disrupt and physically remove biofilms, while increasing and prolonging saliva flow. In a preferred embodiment of the invention, the coated biofilm therapy, disposable devices of the invention include a SOFT ABRASIVES® overcoating that is also released, along with the sialagogues, during use to work with the substrate to help physically remove biofilms. Working these disposable, one-handed devices interproximally, massages interproximal soft tissues thereby increasing blood flow. The simultaneous release of sialagogues or various saliva soluble coatings containing sialagogues, while working these devices interproximally increases and prolongs saliva flow.

As used herein, the term “additional adjuvants” refers to additional ingredients that can be added to the sialagogue emulsion to provide color, or sweetening effects, as desired. Examples of suitable sweetening agents include sorbitol, sodium cyclamate, and saccharine, commercial materials such as Nutrasweet® brand of aspartame, xylitol and sucralose. Citric acid or acetic acid is often utilized as a flavor modifier and is generally used in amounts of about 1.0 to about 20 percent by weight, preferably about 2.0 percent to about 15 percent by weight.

As used herein, the term “buffering ingredient” refers to substances that may also be added to the flavored sialagogue emulsions of the invention in order to prevent natural degradation of the flavoring components or therapeutically active ingredients. Generally, the pH of these compositions is adjusted from about 3.5 to about 8, depending on the chemistry of the active ingredient most requiring protection. Buffering ingredients such as an alkali metal salt of a weak organic acid, for instance, sodium benzoate, sodium citrate, sodium phosphate, sodium bicarbonate or potassium tartrate is generally added in an amount of about 0.1 to about 1.0 percent by weight. Other buffering agents such as weak organic acids or salts of weak bases and strong acids such as boric acid, citric acid, ammonium chloride, etc., can also be used in similar concentrations.

As used herein, the term “stabilizers” refers to substances that are often added along with the flavor to the sialagogue emulsion for additional control, such as:

(a) sodium benzoate, sodium or potassium sorbate, methyl paraben, propyl paraben and others approved for ingestion, and

(b) chemical oxidative control substances, such as ethylene-diaminetetraacetic acid, BHA, BHT, propyl gallate and similar substances approved for ingestion. Concentration levels of these stabilizers comply with industry and regulatory standards.

As used herein, the term “SOFT ABRASIVES®” defines saliva-soluble and saliva-insoluble abrasive substances added to the coated dental devices of the invention that are suitable for cooperating with the various disposable, one-handed dental devices of the present invention to remove, control and disrupt biofilm, tartar and stained pellicle from tooth surfaces. SOFT ABRASIVES® include: tetrasodium pyrophosphate, calcium carbonate, dicalcium phosphate, silica, glass beads, polyethylene and polypropylene particles, pumice, titanium oxide, alumina, quartz, aluminum silicate, etc., at various particle sizes suitable for use in oral care. See U.S. Pat. No. 6,575,176.

As used herein, the term “cleaners” refers to essentially all surfactants suitable for use in the oral cavity and suitable for coating various oral products of the present invention.

As used herein, the phrase “chemotherapeutic ingredients” refers to those substances other than sialagogues suitable for addition to the coatings of the present invention that impart therapeutic effects to the oral cavity including antimicrobials; anti-tartar and anti-plaque substances; remineralizing, desensitizing, NSAID and antibiotic ingredients, and the like. Specific chemotherapeutic ingredients suitable for the present invention include: stannous fluoride, potassium nitrate, cetylpyridinium chloride (CPC), triclosan, metronidazole, chlorhexidine, aspirin and doxycycline.

As used herein, the phrase “crystal formation eliminating additives” is defined as those coating additives that reduce, control and/or eliminate crystal formation and enhance the substantivity of the sialagogue-containing coating to dental devices of the invention when added to these coatings at modest levels. These include certain aliphatic, long chain, fatty alcohols having from between about 10 and 30 carbon atoms and/or various liquid surfactants such as polyethylene glycol sorbitan dialiphatic esters.

Aliphatic, long chain, fatty alcohols are suitable for the crystal-free, sialagogue emulsion coatings of the present invention. These can be represented by the structural formula ROH, wherein R represents a long chain alkyl group having from 20 to 30 carbon atoms. Specific examples include:

| | | |
|---|---|---|
| 1-decanol | 1-heptadecanol | 1-pentacosanol |
| 1 undecanol | 1-octadecanol | 1-hexacosanol |
| 1-dodecanol | 1-nonadecanol | 1-heptacosanol |
| 1-tetradecanol | 1-decosanol | 1-octacosanol |
| 1-pentadecanol | 1-henticosanol | 1-nonacosanol |
| 1-hexadecanol | 1-tricosanol | 1-triacosanol |
| 1-tetracosanol, | and mixtures thereof. | |

Naturally occurring mixtures with substantial quantities of these fatty alcohols, or isomers thereof, including those chemically derived from natural sources also constitute suitable sources of aliphatic, long chain fatty alcohols for the purpose of this invention.

The long chain fatty alcohols can be purchased commercially from Stepan, Procter & Gamble and Aldrich Chemical Co. and a variety of companies processing vegetable and animal derived fatty alcohols.

### Methods for Coating Clean Perception Oral Products

Various post-coating operations such as dipping, soaking and spraying have been used to coat one-handed devices. Unfortunately, the resultant coating levels are difficult to control as indicated by the substantial coating build up that is generally encountered during drying. This results in unpleasant-appearing, consumer unfriendly, coated devices that “turn-off” most consumers who try them.

Surprisingly, it has been found that various confectionery coating processes can be modified and controlled, when used with sialagogue emulsions for coating certain oral products of the invention, including disposable, one-handed dental devices including dental picks, dental flossers and proxy brushes, as well as confectioneries, nutraceuticals and chewable medicaments. The resultant multi-coatings of various sialagogue/surfactant mixtures impart high-impact hedonics to these oral products. These multi-coated sialagogue/surfactant oral products are: not sticky to handle, pleasant to look at, easy to use, and most importantly deliver clean perception to the oral cavity. Depending on the flavor-sealed packaging used, these high-impact coatings are stable for prolonged periods and, accordingly, are commercially feasible for use on various oral products of the invention.

The primary mechanical requirement of any selected process and apparatus used for coating certain one-handed devices and certain oral products is the ability to suspend these products in the air, or otherwise provide movement of these products during the coating/drying operations which prevent the accumulation of the coating agents at the points of contact between these products and the apparatus, thereby avoiding “pooling” of the coating agents while they are still liquid and then drying in the “pooled” state. It will be obvious to one skilled in the art that allowing a manufacturing opportunity for droplets or areas of high concentration to occur at various places on these products of the invention during drying would be counterproductive to the intent of the invention.

There are several established confectionery coating processes and apparatus, which can be adapted by one skilled in the art to coat certain one-handed devices, confectioneries, nutraceuticals and medicaments of the invention with multiple coatings of sialagogue emulsions. These include:

(a) pan coating: both batch and continuous, as described in U.S. Pat. Nos. 5,010,838; 4,334,493; 3,911,860; 4,245,380; 3,448,718; 3,063,843; and 2,726,959.

Additional pan coating references include:

For example, U.S. Pat. No. 4,334,493, to Okawara shows a rotary drum type apparatus for applying a coating to products which includes a rotary drum supported by a frame for receiving a body of devices to be coated by spraying with a solvent. The drum which can be inclined through about 10-20″ in such a manner that its front surface is turned upwardly, includes a device which supplies a coating material into the interior of the drum and an inlet tube and an outlet tube to provide a supply of drying gas such as air to the interior. The support frame cooperates with an outer periphery of the drum to define an air suction duct disposed on the front side of the support frame and an air exhaust duct disposed on the rear side of the support frame so that a smooth flow of hot blast through the drum can be obtained.

Similarly, in U.S. Pat. No. 4,245,580 to Okawara, a device for coating granular solids is disclosed which has a double-cone rotary drum perforated so as to permit flow of air or gas into and out of the rotary drum, and which is tiltable about the axis at right angles to the axis of rotation of the rotary drum so that in the case of the discharge of product solids, the opening of the rotary drum may be directed downwardly. Axial annular insulating covers are providing which insure the effective thermal insulation of the rotary drum when the hot air or gas is blown thereinto. However, each of the Okawara disclosures discussed above relate to coating drums for batch operation since each body of cores to be coated must be fed into and discharged from a single opening. Similar operation and apparatus are shown in U.S. Pat. Nos. 3,448,718; 3,063,843; and 2,726,959.

U.S. Pat. No. 3,911,860 to Nohynek discloses a coating drum for continuous coating of dragees with a coating material and for subsequent application and glossing of a protective skin over the coating by use of a co-axially connected after-treatment drum. In particular, both drums are fixed in a scaling to each other and may be driven at different speeds by means of a variable speed transmission rotationally interconnected. The dragee drum shown by Nohynek is a double frustum, while the after-treatment drum is cylindrical. Both drums are equipped with a conveying baffles in order to push the product through from the entrance to the exit.

(b) fluidized bed/wurster machine coating: as described in U.S. Pat. Nos. 6,911,087; 3,196,827; 3,110,626; 4,330,502; 4,535,006; 5,236,503; 6,579,365.

In most of these fluidized bed techniques, the container acts as a processing zone in which the oral products are processed, dried and/or treated. In order to optimize the processing of the oral products, a certain spatial extent of the processing zones and/or of the extension of the fluidized bed is required, particularly with regard to the “flight altitude” of the oral products. An analogous rule applies to fluidized bed granulation. One means of controlling the fluidized bed is by varying the gas flow into the processing zone. As is well known, this can be accomplished by manually changing the air volume, e.g., by means of an air slide, until the desired height of the fluidized bed has been achieved. The modification of the setting, as well as the monitoring of the fluidized bed zone, usually takes place visually by an operator. However, in order to maintain a constant altitude to the fluid bed zone, a continuous control is necessary, since, under certain circumstances during the treatment process, modifications of the material to be processed may occur that necessitate corresponding modifications of the “flight altitude” of the oral products. It is also necessary to make different adjustments in situations where the material to be processed is different. Consequently, for good results during processing, expensive and cumbersome monitoring and manual setting by an operator are necessary. However, even careful monitoring by an operator cannot insure that an optimal setting is maintained continuously throughout the processing period. Optical illusions may affect the operator during visual control which can result in processing the oral products in an undesirable manner.

Additional fluidized bed references include:

U.S. Pat. No. 3,110,626 to G.L. Larson et al. discloses an apparatus whereby coating discrete solids suspended in a moving air stream is carried out within the interior region of a velocity concentration control element mounted in the base region of a funnel-shaped coating chamber. However such apparatus does not include any means for shielding the base of the spray pattern with an upwardly flowing column of air in order that the spray pattern may substantially develop before entrance thereinto of discrete solids to be coated.

U.S. Pat. No. 4,335,676 to Christian Debayeax et al. discloses a spouted bed granulating and/or coating apparatus wherein flow directing structure is provided to direct the gaseous flow stream in the upward direction for preventing contact and agglomeration of particles in the vicinity of the walls with the oral product. This patent fails to disclose structure by which the lower portion of the spray pattern is protected by an upwardly flowing column of air in order that the spray pattern may more fully develop before the entrance thereinto of particles to be coated.

U.S. Pat. No. 4,701,353 to Stanislaus M.P. Mutsers et al. discloses an apparatus whereby the liquid spray material is discharged out of a central channel as a vertically closed, conical film with a thrust exceeding the thrust of the gas streams for the purpose of causing the conical film to be nebulized to very fine droplets with the air of the surrounding gas stream. The resultant spray pattern is not protected about its initial base end by an upwardly moving column of air disposed thereabout.

U.S. Pat. No. 4,960,224 to Gustav A. Magg et al. discloses an atomizing nozzle constructed in a manner to eliminate the need to provide a metering pump or flow meter for each atomizing nozzle of an associated fluidized coating bed with the control of the flow through each atomizing nozzle being accomplished by varying the internal bone size of the flow control tubes. However, this patent fails to disclose structure for shielding the resultant spray pattern from immediate entrance thereinto of particles to be coated before the spray pattern is reasonably developed.

U.S. Pat. No. 4,858,552 to Werner Glatt et al. discloses an apparatus whereby a fluidized current carries particles, while still plastic, upwardly through a channel device for agglomerated material disposed at a distance above the perforated base causing the particles to impinge on the underside of a rotatable means provided for shaping the agglomerated material. The Glatt et al. apparatus does not disclose structure by which the particles to be coated are shielded against entry into the initially forming spray pattern.

U.S. Pat. No. 3,196,827 to D.E. Wurster et al. discloses a tubular partition defining an upbed therein into which an air and spray discharge pattern is directed and wherein a downbed of particles in near weightless suspension is disposed outwardly of the tubular partition, the spray nozzle being disposed below the bottom of the partition above the associated air distribution plate or screen. With this device, particles being coated are also free to immediately enter the lower beginning portion of the spray pattern.

(c) Dragee coating: as described in: Silesia Confiserie Manual #2 Special Handbook for Dragee and U.S. Pat. Nos. 5,171,589; 4,649,855; 3,831,262; 5,334,244; 3,095,326; 4,105,801; 4,753,790; 4,250,195; 3,554,767; 2,304,246; 2,460,698; 3,208,405; 3,635,735; 4,238,510 and British Patent Nos. 922,495 and 1,047,349.

Certain oral products of the present invention, including one-handed devices, confectioneries, nutraceuticals and medicaments, can be coated with sialagogue and emulsion mixture coatings using various confectionery coating drums which introduce the mixture onto the surfaces of these oral products while the products are in motion within the coating drum. Two general types of machines can be adapted to the coating process of the present invention. The first machine tumbles these oral products within a horizontally rotatable drum while the sialagogue emulsion coatings are sprayed into the drum. The second uses a vertical flow of air to circulate these oral products past a vertically disposed spray nozzle used to introduce the sialagogue and emulsion mixture coatings into the drum.

Three types of dragee coating processes that are adaptable to coating these oral products of the invention with multiple coatings of sialagogue and emulsion mixtures are detailed below:

1. Dragee Kettle:
For most applications the exact thickness of the coated layer is not critical and many different types of coating machines may be used to apply a crude, yet effective coating to the oral product. An older once popular type of coating machine is called a dragee kettle and examples of these machines are disclosed in U.S. Pat. Nos. 3,831,262 and 5,334,244. This machine includes a large drum-like vessel which is typically rotated about a horizontal axis. The vessel includes a coating chamber which is partially filled with oral products to be coated so that as the vessel rotates, the products roll and tumble along the inside wall of the coating chamber. During this tumbling motion, sialagogue and emulsion mixtures in the form of aqueous suspensions of liquids are sprayed through nozzles and into contact with the rolling products within the coating chamber. During the coating process, a current of temperature-controlled air circulates in the coating chamber of the dragee kettle, which helps evaporate the water of the coating emulsion so that the sialagogue and emulsion mixture coating effectively dries and adheres to the oral products.

One problem with the dragee kettle coating machine is that typically the oral products are not the only surfaces coated within the coating chamber. Even when a carefully controlled spraying schedule is followed (such as spraying at very short intervals while the dragee kettle rotates), much of the sprayed coating material still ends up on the inside wall of the coating chamber, as well as throughout the evaporation/venting ducting. This over-spraying creates numerous contamination and cleaning problems, and further increases the cost of the coating since much of the coating material is lost during the coating process.
The above-described dragee kettle type coating machine is limited to coating oral products which do not require much precision in the thickness of the multi-coated layer because the thickness of the coating of the devices will vary in the same batch. This process may be used to coat many different oral products, as long as uniform coating distribution and thickness are not required.

2. Perforated Pan:
The next generation of oral product coating machines after the dragee kettle is called a perforated pan coating machine. This machine has improved the oral product coating process and is the most common type of dragee coating machine in use today. The perforated pan machine includes a rotatable perforated drum which rotates about a horizontal axis within a housing, and further includes a plurality of nozzles positioned within the drum. The nozzles create a spray of sialagogue emulsion within the drum so that any products located within the drum will tumble about into and out of the spray pattern and, over a period time, will accumulate a coating throughout. An important improvement of the perforated pan coating machine over the dragee kettle is that the perforated pan machine allows air directed through the housing (using appropriate ducting) to pass through the perforated drum and quickly reach the oral products tumbling therein. The perforations of the drum effectively expose the tumbling products to the current of air, resulting in more uniform distribution of drying air for each product. The drum further includes solid baffles which are used to enhance mixing of the product bed in an effort to improve the distribution of the sialagogue emulsion being sprayed onto the oral products.

3. Fluidized Bed Coating Machines:
Another type of oral product coating apparatus is called a fluidized bed coating machine (also known as a Wurster machine, after inventor Dale Wurster). These have been discussed above. Several examples of the Wurster coating machine are disclosed in U.S. Pat. Nos. 3,196,827; 3,110,626; 3,880,116; 4,330,502; 4,535,006 and 5,236,503.
The Wurster coating machine is typically used to layer and coat granules or pellets of solid materials, including pharmaceutical drugs.
As described below, the Wurster machine generates an upward stream of air or other gases such as nitrogen to circulate an oral product through a vertical spray of sialagogue and emulsion mixture coating liquid within a product container. As the oral product cycles through the spray, a minute amount of coating material is deposited on its surface. The number of cycles the oral product completes determines the thickness of the final sialagogue and emulsion mixture coating layer.
One preferred embodiment of the present invention includes the use of drageeing kettles, where the axis of rotation is tilted to the horizontal. As a rule, such kettles have a pear-, tulip- or onion-shape in cross section. They are usually mounted on one side and have, on the side opposite to the mounting, a filling opening which, during operation, can be closed by a lid.
In such a kettle with an axis of rotation inclined to the horizontal, there is obtained a relatively complicated, three-dimensional movement, which, for example, is described in detail in an article by K.H. Bauer in “Pharmazeutische Industrie”, 39, 149-156/1977. Because of the fact that, in this case, the direction of action of the gravitational force differs from that of the centrifugal force or of the frictional force emanating from the walls of the container, in such a kettle the sialagogue and emulsion mixture coating in its deepest lying region is, roughly following the mantle line of the drageeing kettle, transported obliquely upwards as ascending material in the direction of the rotation of the kettle. It thereby obliquely reaches a zenith from which, as descending or running off material, it flows back counter to the rotational movement of the kettle. Because of the tilt of the kettle therefore, the descending material has a movement component towards the axis of the kettle so that, on average, it is closer to the axis of kettle rotation than the ascending material. As is to be seen from the above-cited article, due to this three-dimensional rolling movement of the sialagogue and emulsion coating mixture, there is achieved a better mixing up and thus a more uniform coating of the oral products than in the case of the use of a kettle with a horizontal axis of rotation.
The sialagogue and emulsion mixture is periodically introduced into the coating drum, thereby applying successive coats to the oral products which are being maintained in constant motion by the movement of the coating drums. Each coating application is followed up by a drying/tumbling interval during which substantially all of the moisture in the emulsion is expelled from the coated oral products via the use of controlled air flow and the application of controlled heat. The duration the sialagogue emulsion coating mixture is introduced into the coating drum usually ranges from between about 10 and about 120 seconds and preferably from between about 20 and about 75 seconds. The duration between sprays for drying the coating generally ranges from between about 2 and about 4 minutes. After this spray cycle, the sialagogue and emulsion coating mixture on the oral products loses substantially all of the moisture as the discrete sialagogue and emulsion coating layer forms and dries. Care must be taken not to over dry or overheat the coated products before a subsequent coating is added. Evidence of overheating or over drying is the presence of flakes of coating material in the pan coating drum.

4. Vibrating Screen Coating Machines:
Another type of oral product coating apparatus is called a vibrating screen drying machine. In such an apparatus, the items to be coated and dried are conveyed through a drying section, providing a flow of either cool air or warm air, on a vibrating screen which “bounces” the parts into the air by the high amplitude vibration of the screen. The coating material can be applied by a variety of methods, two examples of which will suffice to illustrate the breadth of possibilities available to one skilled in the art. (1) the parts are immersed into the solution and transferred to a draining screen or screen conveyer for the removal of excess liquid before being transported to the vibrating screen (itself often in the form of a moving conveyer) for drying, or (2) spray devices are placed at strategic locations along the moving, vibrating screen to apply a series of “coats” between drying stages.
The total number of sialagogue and surfactant mixture coatings on the oral products of the invention generally ranges from between about 1 and about 50 coatings and preferably from between about 4 and about 10 coatings.

All of the various confectionery coating apparatus and methods described above can be adapted by one skilled in the art to coat various oral products of the invention with sialagogue emulsions.

### Sialagogue Component

This physical state of the sialagogue component can range from:
a solution, to
an emulsion, to
a dispersion.

depending on the level of various ingredients present. The sialagogue component is defined as a natural or synthetic compound or mixture of compounds that cause an increase in saliva in the mouth. In other words, sialagogues are substances that stimulate the production of saliva.

There are two important types of sialagogues:

1. Gustatory sialagogues, i.e., materials related to the sense of taste, such as particular foods and flavors. Particularly preferred sialagogues include:

ascorbic acid, black pepper, ginger, licorice, pilocarpine, affinin, spilanthol, bethanechol chloride, cayenne pepper, echinacea, verba santa, bay berry, sanguinarine, ginseng, kava, kudzu, capsaicin, zingerone, eugenol, and piperine; and

2. Pharmaceutical sialagogues (also called parasympathomimetic agents) which improve salivation.

Examples of other preferred sialagogues of both types, useful in the present invention, include:

1. plant extracts including: amides of vegetable origin including:
(a) affinin, i.e., N-isobutyl-2,6,8-decatrienamide,
(b) Ciluan Root derivatives, including Heliopis Longipes,
(c) bioactives N-isobutylamides from buds of Spilanthes acmella,
(d) alkamides present in flavoring plants including affinin and capsaicin, and
(e) N-alkyl-carboxamide compounds, including 3-(1-menthoxy)-propane-1,2 diol-1-(2-hydroxyphenyl)-4-(3-nitrophenyl)- 1,2,3,5-tetrahydropyrimidine-2-one; and

2. compositions such as described in U.S. Pat. Nos. 5,585,424; 6,780,443;

6,890,567; 6,899,901; U.S. Pat. PublicationNos. 2003-0215532 and 2004-0052735. See also: Journal of the Society of Cosmetic Chemists, 29:185-200 (1988) H.R. Watson. Preferably such compositions contain at least one Jambu Oleoresin and one Spilanthol;

3. “Spilanthes” which are a strong anti-bacterial herb with in-vitro activity against such common pathogens as: Escherichia coli, Klebsiella pneumoniae, Proteus vulgaris, Pseudomonas aeruginosa, Salmonella gallinarum and Staphylococcus albus. Spilanthes also inhibits the yeast/fungal organism Candida albicans, which is responsible for the nearly epidemic condition known as candidiasis (thrush); and

4. “Heliopsis longipes”, which are herbaceous plant species found in Mexico, was disclosed over fifty years ago as having possible commercial value as a source of insecticide. Little, Jr., E. L., Heliopsis longipes, a Mexican insecticidal plant species, Journal of the Washington Academy of Sciences, Vol. 38, No. 8, pp. 269-274 (Aug. 15, 1948). More particularly, the roots of Heliopsis longipes have been used in Mexico to make local insecticides. Id. This use of the plan was discontinued over four decades ago. While this was one use of Heliopsis longipes roots, these roots have been used primarily as a spice or flavoring, as chewing the root causes numbness and tingling in the mouth and tongue and stimulates salivation. Id. These roots were also chewed to relieve toothache. Id. One incident is reported of an adverse effect, when a great, but undisclosed, quantity of the roots was eaten. Id.
Extracts from the roots of Heliopsis longipes have been used in a few medical applications. Id. For example, reportedly, such an extract has been used for treating colds and pneumonia, and an alcoholic extract has been tested for use as an anesthetic for tooth extraction. Id. It has also been reported that an extract of these roots possesses antiseptic properties. Molina-Torres, J., et al. Antimicrobial properties of alkanides present in flavouring plants traditionally used in Mesoamerica: affinin and capsaicin, Journal of Ethnopharmacology, Vol. 64, Iss. 3, pp. 241-248 (March 1999). A crude methanol extract of Heliopsis longipes roots has been described as having the potential to generate anti-infective agents, although this extract reportedly does not show any activity in plate diffusion tests against either E. coli (Gram negative bacteria) or B. subtilis (Gram positive bacteria). Id.; and Gutierrez-Lugo, M. T., et al., Antimicrobial and cytotoxic activities of some crude drug extracts from Mexican Medicinal plants, phyomedicine, Vol. 2 (4), pp. 341-347 (1996). An ethanol extract of Heliopsis longipes roots has been reported as having variable bactericidal effects on E. coli and S. aureus, Romero-R., C. M., et al., Preliminary Studies of the Antibacterial, Insecticidal, and Toxicological Effects of Chiluan Root (Heliopsis Longipes), as translated, Veterinaria Mexico, pp. 151-156 (1989).
Heliopsis longipes roots are known to contain a bioactive alkamide, affinin, identified as N-isobutyl-2E, 6Z, 8E-decatrienamide or N-isobutyldeca-trans-2,cis-6,-trans-8-trienamide. Respectively, Id.; and Crombie, L., et al., Amides of Vegetable Origin, part X. The Stereochemistry and Synthesis of Affinin, Journal of Chemical Society, pp. 4970-4976 (1963). Affinin has also been identified as N-isobutyl 2,6,8-decatrienoamide in one publication, in another publication, and N-isobutyldodeca-2-trans-6-cis-8-trans-trienamide in another publication. Respectively, Jacobson, M., et al., Correction of the Source of “Affinin” (N-Isobutyl-2,6,8-Decatrienoamide, Journal of Organic Chemistry 12, pp. 731-732 (1947) (emphasis added); and Ogura, M., et al., Ethnopharmacologic studies. I. Rapid solution to a problem—oral use of Heliopsis longipes—by means of multidisciplinary approach, Journal of Ethnopharmacology, 5, pp. 215-219 (1982) (emphasis added). Purified affinin, prepared from an ethanol extract of Heliopsis longipes roots, has been reported as being toxic to certain microorganisms, the toxicity varying for Gram positive and Gram negative bacteria. Molina-Torres, J., et al. An aqueous solution of affinin, prepared from a powder of an ethanol extract of Heliopsis longipes roots, has also been reported as having an analgesic effect when administered orally to mice at doses from 2.5 to 10.0 mg/kd, with severe depression of normal motor activity and two out of five deaths occurring at the highest dose. Ogura, M., et al.
In the one publication where affinin is identified as N-isobutyl-dodeca-2-trans-6-cis-8-trans-trienamide, it was said to be identical with spilanthol, the pungent principle of several Spilanthes species. Ogura, M., et al. However, in the publication of Little, Jr., affinin is said to be similar to spilanthol, which has been isolated from flower heads of a species of Spilanthes, Little, Jr., E. L., at p. 270. The flowers and leaves of Spilanthes acmella L. var. oleracea Clarke are reported as having been used as a spice and as a folk medicine for stammering, toothache, stomatitis and throat complaints. Ramsewak, R. S. et al., Bioactive N-isobutylamides from the flower buds of Spilanthes acmella, Phytochemistry 51, pp. 729-732 (1999).
The Heliopsis longipes extract may be prepared using standard means or methods, such as by contacting the plant material with an appropriate solvent to prepare a botanical tincture, or by any other conventional means or method, such as by CO₂ extraction, freeze-drying, spray-drying, and the like. (See Gennaro AR; Remington: The Science and Practice of Pharmacy, Mack Publishing Company, Easton Pa. 1995 and The United States Pharmacopeia 22^{nd} Rev, and The National Formulary (NF) 17 ed, USP Convention, Rockville, Md., 1990.) The extract is prepared using a root or roots of Heliopsis longipes and a solvent, such as water combined with other solvents, an organic solvent, such as hexane and glycerin, or an alcohol, such as ethanol, or any combination thereof. Preferably, an alcohol or a hydro-alcohol solvent is used, and most preferably, ethanol or a combination of ethanol and water is used.
The resulting extract is typically composed of a wet or liquid component that is light brown to golden in color and a dry or solid component, in amounts of about 90.0 to about 99.9 weight percent, such as about 98 weight percent, and about 10 to about 0.01 weight percent, such as about 2 weight percent, respectively, relative to the extract. The composition, including the extract in the wet-dry form just described, may be formulated as a powder or paste, such as a powder including about 66.6 weight percent extract and 33.4 weight percent carrier on a wet basis; or about 0.01 to about 100 weight percent extract on a dry basis-including the natural product sprayed on itself, such as about 2 to 10 weight percent extract on a dry basis, or in any combination or permutation for either method-wet or dry.
Particularly preferred sialagogues include: ascorbic acid, black pepper, ginger, licorice, pilocarpine, affinen, spilanthol, bethanechol chloride, cayenne pepper, echinacea, verba santa, bay berry, sanguinarine, ginseng, kava, kudzu, capsaicin, zingerone, eugenol, and piperine.

The surfactant component of the sialagogue and emulsion mixture includes liquid and solid surfactants, such as:

Liquid surfactants including: polyoxyethylene glycol sorbitan mono- and di- aliphatic esters represented by the general formula: 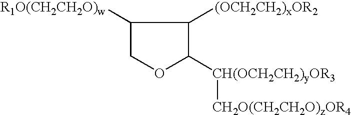
wherein R₁, R₂, R₃, R₄ and H or aliphatic acyl groups having from between about 10 and 30 carbon atoms, and the sum of w, x, y, and z is from between about 20 and about 80. These liquid surfactants are available under the trade name Emsorb®, Span®, Tween® from Cognis, N.A. and ICI. Specific examples of these include: PEG 20 sorbitan monooleate (Tween® 80, ICI); PEG 40 sorbitan monostearate (SPAN 60 ICI) and PEG 40 sorbitan diisostearate (Eumulgin® SDI 40, Cognis N.A.).

Solid surfactants including:
sodium lauryl sulfate,
sodium lauryl sarcosinate,
polyethylene glycol stearate,
polyethylene glycol monostearate,
coconut monoglyceride sulfonates,
sodium alkyl sulfate,
sodium alkyl sulfoacetates,
block copolymers of polyoxyethylene and polyoxybutylene,
allylpolyglycol ether carboxylates,
polyethylene derivatives of sorbitan esters,
propoxylated cetyl alcohol,
block copolymers comprising a cogeneric mixtures of conjugated polyoxypropylene, and polyoxyethylene compound having as a hydrophobe a polyoxypropylene polymer of at least 1200 molecular weight (these surfactants are generally described as poloxamers; specific examples are described in the Examples below) as Poloxamer 407 and Poloxamer 388,
soap powder, and
mixtures thereof.

Preferably, the surfactant is included with a film forming polydimethylsiloxane, i.e., MICRODENT® or ULTRAMULSION®. As used herein, the terms “MICRODENT®” and “ULTRAMULSION®” refer to sialagogue and emulsion mixtures containing polydimethylsiloxane at various molecular weights in various poloxamer surfactants as described and claimed in U.S. Pat. Nos. 4,911,927; 4,950,479; 5,032,387; 5,098,711; 5,165,913; 5,538,667; 5,645,841; 5,651,959 and 5,665,374. These mouth conditioners are preferably included in crystal-free contact coatings of various disposable one-handed dental devices of the invention.

In a particularly preferred embodiment of the invention, the sialagogue emulsion also contains a film-forming agent. Preferably, at least one film-forming agent is utilized in the preparation of the coating mixture. Representative film-forming agents include hydroxypropyl cellulose, methyl cellulose (i.e., methyl ether of cellulose), ethyl cellulose, hydroxypropyl methyl cellulose, hydroxymethyl cellulose, carboxymethyl cellulose, gelatin, mixtures thereof, and the like. Preferably, a branched chained film-forming agent such as hydroxypropyl cellulose, is utilized. Preferably, the hydroxypropyl cellulose has a Brookfield viscosity of not less than 145 cps for a 10% aqueous solution at 25° C. The coating emulsion can contain more than one film-forming agent and as such, for example, hydroxypropyl cellulose and methyl cellulose may be utilized. In such a combination the branched chained film-forming agent (e.g., hydroxypropyl cellulose) can be used in amounts of about 0.05 to about 1.5 wt. % with about 0.01 to about 0.5 wt. % being preferred, and the straight chained film-forming agent (e.g., methyl cellulose) can be used in amounts of about 0.5 about 1.0 wt. % with about 0.1 to about 0.5 wt. % being preferred.

Another particularly preferred embodiment of the invention utilizes the unique flavor adsorbing and retention properties of various dry-film forming agents and various surfactants, as described above. The modified cellulose film forming agent and the surfactants function as attractants for flavor molecules, to such an extent that they will adsorb and hold a high percentage of flavor molecules even from volatile sources after the film formers and surfactants have been coated onto the oral products of the invention. This property of adsorbing and holding flavor molecules provides much of the consumer satisfaction associated with the clean perception feature of the present invention, as adsorbed flavor molecules are released upon the coatings dissolving in the saliva, thereby releasing the flavorings accessible to olfactory organs in the oral cavity.

This can be accomplished by coating oral products of the invention with formulation minus the desired flavors and drying the coated devices by one of the mechanical procedures described above, followed by a final step of introducing volatile flavoring agents from the flavor reservoir. The coated devices can then be packed in consumer packaging material which is a sufficient barrier to flavor molecules to allow the flavors to be volatilized inside the container. This is easily accomplished by placing the desired quantity of volatile flavor oils into a flavor reservoir such as on a piece of adsorbent paper, or into a polymer such as polyvinylacetate (Elvax® as supplied by DuPont) which adsorbs/desorbs at a high rate, into the package. Equilibrium is quickly established so that the bulk of the flavor moves from the flavor reservoir into the dry-film forming agents and/or surfactants present in the coated oral products.

In another embodiment, to reduce the loss of volatile flavor molecules during the high temperature/high velocity air contact of the coatings during drying with the dragee method, the dental devices are coated to the desired thickness with a dry-film forming composition minus the volatile flavoring agents. As a last step, an alcoholic solution of the flavor oils is sprayed or otherwise introduced onto the moving oral products in the dragee kettle for distribution across the surfaces. In the same manner that an alcoholic solution of perfume oils can be applied to the skin and dry off leaving almost all the perfume oils adsorbed into the skin, the alcoholic carrier of the flavor oils volatilizes off at very low temperatures which essentially eliminates the loss of volatile flavor oils. The thin film of flavor oils so deposited on the previously laid down oral product coating is almost instantly adsorbed due to the adsorption properties of the dry-film forming agents and/or surfactants. Surprisingly, any dis-uniformity in flavor oil across the surface of the oral product is quickly made uniform by the inexorable principles of equilibrium as the oils move from points of higher concentration in the coating to those of lower concentration until equilibrium is reached.

It is self-evident in the forgoing preferred embodiments that non-volatile flavor components, such as sweeteners, must be added to the initial un-flavored coatings as they cannot be transferred easily by equilibrium techniques.

Other substances can be added to the sialagogue and emulsion mixture coating including:
(a) A flavoring agent may be present in the emulsion in an amount within the range of from about 0.1 to about 10.0 wt. %, and preferably from about 0.5 to about 3.0 wt. %, of the emulsion. The flavoring agents may comprise essential oils, synthetic flavors, or mixtures thereof including, but not limited to, oils derived from plants and fruits such as citrus oils, fruit essences, peppermint oil, spearmint oil, clove oil, oil of wintergreen, anise and the like. Artificial flavoring components are also contemplated for use in coating emulsions of the present invention. Those skilled in the art will recognize that natural and artificial flavoring agents may be combined in any sensorially acceptable blend. All such flavor sand flavor blends are contemplated by the present invention.
(b) The colorant used may include dyes, pigments, lakes and natural colors. The colorant may be blended with melted wax, preferably carnauba wax, which melts at 80°-90° C., then cooled and ground to a find particle size that will pass at least 99% through a #100 mesh sieve (less than 150 microns). Other waxes that may be used include beeswax, candelilla wax, spermaceti wax, and mixtures of the foregoing. Another method of blending is to powder blend the colorant with the wax. In either method, the preferred ratios are 1-30% colorant and 70.99% wax, and more preferably 5-15% colorant and 85-95% wax. It is preferable to use powdered colorants that have a particle size that will pass at least 99.9% through a #325 mesh sieve (small than 45 microns) so that the blended color/wax will still pass at least 99% through a #100 mesh sieve, having a particle size of 150 microns or less.
(c) Artificial sweeteners such as the soluble saccharin salts, i.e., sodium or calcium saccharin salts, cyclamate salts, acesulfam-K, and the like, and the free acid form of saccharin may optionally be added to the sialagogue emulsions. Dipeptide sweeteners such as L-aspartyl-L-phenylalanine methyl ester and materials described in U.S. Pat. No. 3,492,131, and the like may also be used. These sweeteners may be used in amounts of about 0.005 wt. % to about 0.5 wt. % based on the weight of the total coating emulsion, and preferably about 0.05 wt. % to about 0.25 wt. %. Usually the first coating emulsion can contain about 0.02 wt. % to about 0.06 wt. % and most preferably 0.05 wt. % of artificial sweetener. A second emulsion can usually contain about 0.05 wt. % to about 0.2 wt. %, based on the weight of the coating emulsion, with about 0.08 wt. % to about 0.15 wt. % being preferred of artificial sweetener.
(d) If desired, flavoring may be added to the sialagogue and emulsion mixture. The flavoring in the coating emulsion will be present in an amount within the range of from about 0.5 to about 5% and preferably from about 1.25 to about 4% by weight of the emulsion. Such flavoring may comprise oils derived from plants, leaves, flowers, fruit, etc. Representative flavor oils of this type include citrus oils such as lemon oil, orange oil, lime oil, grapefruit oil, fruit essences such as apple essence, pear essence, peach essence, strawberry essence, apricot essence, raspberry essence, cherry essence, plum essence, pineapple essence, as well as the following essential oils: peppermint oil, spearmint oil, mixtures of peppermint oil and spearmint oil, clove oil, bay oil, anise oil, eucalyptus oil, thyme oil, cedar leaf oil, cinnamon oil, oil of nutmeg, oil of sage, oil of bitter almonds, cassia oil, and methylsalicylate (oil of wintergreen). Various synthetic flavors, such as mixed fruit, may also be incorporated in the sialagogue/emulsions of the invention with or without conventional preservatives.

In a particularly preferred embodiment of the invention, the polyalcohol, xylitol in a mixture with mono-, di- and triglycerides of the fatty acids of: palmitic, stearic and oleic acids, is included in the sialagogue and emulsion mixture. Xylitol can be represented by the structured formula:

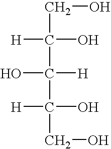

Xylitol is commercially available both in solid form and in the form of aqueous concentrated solutions. However, contrary to the saccharose shell, that of xylitol deteriorates rapidly with time. In particular, already after a few hours a xylitol shell cracks and its outer surface initially smooth becomes wrinkled; at the same time even the intimate constitution of the shell, initially sufficiently microcrystalline, changes into a course, rough structure fastidious to the palate and in chewing. A xylitol/sialagogue coating offers the peculiar advantage of being refreshing to the mouth (owing to an appreciable negative heat of solution); however, this advantage does not compensate the aforesaid drawbacks.

Those mixtures of glycerides are preferred which exhibit a strong prevalence of a determined glyceride. Mono- and diglycerides suitable for the purposes of this invention may present a melting point ranging from about 400 to about 70° C., keeping in mind that the melting point can be lowered (owing to formation of eutectics) by addition of a triglyceride having a convenient melting point. The preferred fatty substance is cocoa butter which, as is known, melts around 35° C.

The invention will be further understood by those skilled in the art upon reviewing the Examples set forth below.

### EXAMPLE 1

A 2 gallon S.S. drum mounted on a 35 degree angle is fitted with 4 fins 1.5 inch high. The drum is rotated at 20 RPM loaded with 200 flossers weighing 685 mg each. A vegetable pump sprayer is filled with an emulsion prepared as follows: One hundred mL of DI water is added to glass beaker (A) fitted with a magnetic stirrer and heated to 90° C. with 15 grams of hydroxypropylcellulose powder slowly added over 2 minutes. Glass beaker (B) is fitted with a magnetic stirrer and 300 mL of water heated to 40° C. Twelve grams of ULTRAMULSION® 10/2.5 (a solid emulsion of Pluronic F-108, 90% and polydimethylsiloxane, 2.5 million centistokes, 10%) was added to the water over one minute. After 10 minutes the ULTRAMULSION® had dispersed and 10 grams of peppermint flavor with Multisensate (IFF SN584170) and 1.5 grams of cooling agents WS 3 and WS 23 were added. Sodium saccharin, 4 grams, was added all at once to the water in beaker B. Heating was removed from the glass beakers and the contents of beaker B was added slowly to beaker A with magnetic stirring. After 30 minutes of air cooling, the temperature cooled to 35° C. The prepared solution was then added to the pump sprayer. Each pump delivered 0.8 grams of liquid. Five pumps of the spray solution were applied while the drum was rotating. An air stream of 60° C. is applied such that the flossers dried over 3 minutes. The application procedure was repeated 3 times to give a total of 20 sprays delivering 16 grams of solution. After the last application and drying sequence, the flossers were dry to the touch and had a coating of 15 mg per flosser. These flossers can be packaged in flavor-sealed packaging fitted with a flavor reservoir to impart clean perception attributes.

### EXAMPLE 2

A commercial pan coating machine possessing a 48 inch diameter pan was loaded with 14,400 flossers weighing 685 mg each. The pan was fitted with 6 fins internally of UHMW polyethylene angle stock of ¾ inch on each side. The pan rotated at 20 RPM and was fitted with a heated air supply variable between 38° C. and 60° C. A 4 L glass beaker (A) was fitted with a lightning mixer and heater. The 823 mL solution of DI water was added. Hydroxypropylcellulose, Klucel LF, 123.5 gm, was added slowly with stirring to water at 90 degrees with stirring. A second 4 L beaker (B) was fitted with a lightning stirrer and heater. DI water, 2470 mL, was added to beaker B and heated to 40° C. ULTRAMULSION® 10/2.5 powder, 99 grams, was added slowly with stirring over three minutes and stirring continued over 15 minutes until a uniform emulsion was observed. A solution of peppermint flavor, 63 grams; Multisensate, 1.45 grams (IFF SN584170); cooling compounds WS-3, 1.05 grams; and WS-23, 1.05 grams, were added slowly over 3 minutes with stirring to aqueous emulsion. The contents of beaker B were added with stirring to beaker A and heating was removed. After one hour the emulsion had cooled to 35° C. The aqueous emulsion was then added with a 250 mL ladle in 4 aliquots of 900 mL each with air drying applied at 60° C. After the first aliquot, the air stream and tumbling took about 8 minutes for the flossers to move freely over each other. Then the second aliquot was added with the ladle and it took 10 minutes for the flossers to move freely over each other. The third and fourth aliquots were applied with drying between aliquots. Total drying time was about 45 minutes. The flossers were weighed and each flosser had 15 mg of coating. Peppermint flavor was very strong and the cooling and tingling of the multisensate was observed on the tongue. The flossers were then placed in flavor-sealed packages, fitted with a flavor reservoir to impart clean perception properties.

### EXAMPLE 3

A pan coating machine fitted with a 48 inch diameter pan was rotated at 20 RPM while a 38° C. air stream was directed onto 12960 tumbling flossers, each 844 mg. An aqueous emulsion prepared as in Example 2 using a vanillamint flavor, 55.5 grams; cooling WS-3, 1 gram, WS-23, 1 gram; and Multisensate, 1.3 grams, was added in a similar fashion. Drying times between aliquots was increased to 12 minutes for the first aliquot. The remaining three aliquots were added by ladle and total drying time was one hour 5 minutes. The flossers were dry to the touch and tasted strongly of vanillamint with a cooling sensation that lasted about 15 minutes. The tingle sensation was apparent on the tongue. The flossers were then packaged under flavor-sealed conditions with a flavor reservoir to impart clean perception properties.

### EXAMPLE 4

The pan coating arrangement and solutions of Example 3 were repeated with 38° C. air supply. Flossers (6912 pieces) at 1.45 grams each, were tumbled while an emulsion of grape flavor, 30 grams; ULTRAMULSION® 10/2.5, 70.8 grams; cooling agent WS-3, 0.75grams, WS-23, 0.75 grams; and 1.5 grams Multisensate was ladled on the flossers in 4 aliquots. After 1 hour and 10 minutes, the flossers were dry to the touch and tasted strongly of grape with a cooling and tingling sensation to the tongue and throat. These flossers were available for flavor-sealed packaging fitted with a flavor reservoir.

### EXAMPLE 5

To a 600 mL glass beaker (A) was added deionized water, 100 grams, and heated to 90 degrees C. Fifteen grams of Klucel LF (hydroxypropylcellulose) was added slowly with stirring. To a second glass beaker (B) 300 mL of deionized water was added and heated to 40° C. with stirring. Twelve grams of powdered ULTRAMULSION® 10/2.5 was added over 3 minutes to beaker (B). After 15 minutes of stirring, vanillamint flavor, 10 grams, was added to beaker (B). Fifteen grams of Jambu oleoresin containing spilanthol was then added to beaker (B) with stirring over 2 minutes. The contents of beaker (B) was then added to beaker (A) and then cooled to 35° C. One thousand grams of triangular double-ended toothpicks obtained from Norway were added to a 28 inch coating pan fitted with hot air at 60° C. The solution was divided into 4 aliquots and each aliquot sprayed onto the toothpicks rotating at 20 RPM. The tumbling continued until dry to the touch after which the next aliquot was sprayed on to the toothpicks. After all four aliquots were added and dried, the toothpicks were removed to give a coating level of 3 mg per toothpick. The toothpicks were available for flavor-sealed packaging fitted with a flavor reservoir.

### EXAMPLE 6

To a 600 mL glass beaker (A) was added deioni ed water, 100 grams, and heated to 90° C. Fifteen grams of Methocel K4M was added slowly with stirring. To a second glass beaker (B) 300 mL of deionized water was added and heated to 40° C. with stirring. Twelve grams of powdered Ultramulsion 10/2.5 was added over 3 minutes to beaker (B). After 15 minutes of stirring, vanillamint flavor, 10 grams, was added to beaker (B). Ten grams of Spilanthes acmela oleoresin containing spilanthol was then added to beaker (B) with stirring over 3 minutes. The contents of beaker (B) was then added to beaker (A) and then cooled to 35° C. One thousand grams of round toothpicks obtained from China were added to a 28 inch coating pan fitted with hot air at 60° C. The solution was divided into 10 aliquots and each aliquot sprayed onto the toothpicks rotating at 20 RPM. The tumbling continued until dry to the touch after which the next aliquot was sprayed on to the toothpicks. After all ten aliquots were added and dried, the toothpicks were removed to give a coating level of 2.5 mg per toothpick. These toothpicks can be stored in flavor-sealed packages fitted with flavor reservoirs containing volatile flavors that are adsorbed by the coating on the toothpicks.

### EXAMPLE 7

A 50 mL glass beaker (A) was fitted with a magnetic stirrer and 10 ML of deionized water added and heated to 90° C. Hydroxypropyl-methylcellose, 1.5 grams was then added slowly over one minute and stirring continued over 10 minutes. A 50 mL glass beaker (B) was fitted with magnetic stirring and 30 mL of deionized water added with heating to 40° C. Peg 40 sorbitan diisostearate, Emsorb 2627, was added with stirring over 1 minute. Peppermint flavor, 1 gram, was added to beaker (B). Extract of Heliopsis longipes, 1 gram, was added to beaker (B) over 2 minutes. The contents of beaker (B) were added to beaker (A) and then cooled to 33° C. over 10 minutes. This was then ladled in 10 mL aliquots onto 180 plastic single-ended toothpicks in a 12 inch tumbling drum turning at 21 RPM. Hot air at 38° C. allowed the plastic picks to dry over 15 minutes. Each plastic pick coating weighed 1.8 mg. When these toothpicks are stored in flavor-sealed packages fitted with flavor reservoirs containing volatile flavors, they impart a clean perception, during use.

Tables 1 through 4 below, with examples 8 through 25, further illustrate additional features of the invention.

TABLE 1

| | | | | | | | | Interval | | Volatile Top |
|---|---|---|---|---|---|---|---|---|---|---|
| | | | | Film | | Means for | | between | Wt. of | Note in |
| | Device | Sialagogue | Surfactant | former | Tumbling | introducing | Number | coats | coating | flavor |
| Ex. | (quantity) | (wt. %) | (wt. %) | (wt. %) | Means | coating | of coats | (in min) | (in mg/flosser) | reservoir |
| 8 | flosser | Jambu | Ultramulsion 10/2.5 | hyroxypropyl- | Pan coater | spray | 5 | 2 | 15 | Lemon |
| | (180) | Oleoresin | (0.8) | cellulose | | | | | | |
| | | (0.87) | | (0.87) | | | | | | |
| 9 | flosser | Heliopsis | Ultramulsion 10/2.5 | methylcellulose | Fluidized | ladle | 10 | 1.5 | 16 | Lime |
| | (200) | longipes | (0.6) | (0.65) | bed | | | | | |
| | | (0.35) | | | | | | | | |
| 10 | flosser | Spilanthol | Ultramulsion | carboxymethyl- | Dragee | ladle | 15 | 2 | 20 | Citrus |
| | (96) | (0.00065) | 10/12.5 | cellulose | kettle | | | | | |
| | | | (0.65) | (0.54) | | | | | | |

TABLE 2

| | | | | | | | | | | Volatile |
|---|---|---|---|---|---|---|---|---|---|---|
| | | | | | | | | Interval | Wt. of | Top |
| | | | | Film | | Means for | | between | coating | Note in |
| | Device | Sialagogue | Surfactant | former | Tumbling | introducing | Number | coats | (in mg/ | flavor |
| Ex. | (quantity) | (wt. %) | (wt. %) | (wt. %) | means | coating | of coats | (in min) | pick) | reservoir |
| 11 | triangular | Jambu | Ultramulsion 10/12.5 | hyroxypropyl- | Pan coater | spray | 5 | 2 | 3.2 | Lemon |
| | double-ended | Oleoresin | (0.82) | cellulose | | | | | | |
| | toothpicks | (0.87) | | (0.78) | | | | | | |
| | (2000) | | | | | | | | | |
| 12 | round | Spilanthes | Microdent 10/12.5 | methylcellulose | Fluidized | ladle | 8 | 3 | 2.8 | Peppermint |
| | toothpicks | acmela | (0.68) | (0.7) | bed | | | | | |
| | (1500) | (0.39) | | | | | | | | |
| 13 | plastic | Heliopsis | PEG sorbitan | hydroxypropyl- | Dragee | ladle | 5 | 1 | 1.6 | Lime |
| | toothpicks | longipes | 40 diisostearate | methylcellulose | kettle | | | | | |
| | (200) | (0.3) | (0.5) | (0.78) | | | | | | |
| 14 | round | Spilanthol | Polyoxypropylene | carboxymethyl- | Perforated | spray | 8 | 2 | 1.6 | Tangerine |
| | toothpicks | (0.0008) | (0.37) | cellulose | pan | | | | | |
| | (1500) | | | (0.37) | | | | | | |

TABLE 3

| | | | | Weight of | | | |
|---|---|---|---|---|---|---|---|
| | | Key Coating | | Coatings | | | Comments |
| Ex. | Device | Ingredients | Number of | (as % of wt. | Flavor Reservoir | Tactile Quality | When |
| no. | (source) | (% by wt.) | Coatings | of device) | Top Notes | of Coating | Used |
| 15 | Flosser | MICRODENT ® (34.6) | 10 | 2.4 | Lime | Dry-to-the-touch | Hi-Impact |
| | (DenTek) | Sialagogue (0.5) | | | | | |
| | | Klucel (43.3) | | | | | |
| 16 | Dental Stimulator | MICRODENT ® (13.1) | 1 | 1.8 | Lemon | Dry-to-the-touch | Long lasting |
| | (Jordan) | Sialagogue (2.2) | | | | | |
| 17 | Toothpick | MICRODENT ® (13.1) | 8 | 1.5 | Tangerine | Dry-to-the-touch | Hi-Impact |
| | (Diamond) | Sialagogue (0.5) | | | | | |
| 18 | Plastic Pick | MICRODENT ® (33%) | 8 | 2.2 | Orange | Dry-to-the-touch | Hi-Impact |
| | (Placontrol) | Sialagogue (0.5) | | | | | |
| | | Klucel (22) | | | | | |
| 19 | Flosser | MICRODENT ® (26) | 10 | 2.6 | Lime | Dry-to-the-touch | Long lasting |
| | (Placontrol) | Sialagogue (0.25) | | | | | |
| | | Klucel(11) | | | | | |
| 20 | Proxy Brush | MICRODENT ® (15.6) | 1 | 2 | Lemon | Dry-to-the-touch | Long lasting |
| | (Perident) | Sialagogue (0.75) | | | | | |
| 21 | Proxy Brush | MICRODENT ® (15.6) | 1 | 2.5 | Tangerine | Dry-to-the-touch | Hi- Impact |
| | (Butler) | Sialagogue (0.7) | | | | | |
| 22 | Mints | MICRODENT ® (15.6) | 4 | 0.75 | Lime | Dry-to-the-touch | Hi- Impact |
| | | Sialagogue (0.7) | | | | | |
| 23 | Nutraceuticals | MICRODENT ® (15.6) | 6 | 1.0 | Lemon | Dry-to-the-touch | Long lasting |
| | | Sialagogue (0.7) | | | | | |

TABLE 4

| | | Key Coating | | | |
|---|---|---|---|---|---|
| | Device | Ingredients | | Flavor Reservoir | Comments |
| Ex. | (source) | (% by wt.) | Overcoating | Top Note | When Used |
| 24 | Dental Tape | MICRODENT ® (39) | Silica | lime | Hi-impact |
| | | Sialagogue (0.4) | SOFT ABRASIVES ® | | |
| 25 | Dental Floss | MICRODENT ® (26) | Pumice | peppermint | Hi-Impact |
| | | Sialagogue (0.25) | | | |

What is claimed is:

1. Oral products with saliva soluble coatings containing flavor absorbing coating substances selected from the group consisting of film-forming substances, emulsions, sialagogue-containing emulsions of surfactant and polydimethylsiloxane, waxes, diglycerol, polyphosphate, sialagogues, hydroxylalkylcellulose film formers and combinations thereof.

2. Oral products according to claim 1, wherein said oral products are flavor-sealed under conditions wherein volatile flavors remain stable, and said oral products are selected from the group consisting of: interproximal dental devices, confectioneries, nutraceuticals, chewable medicaments and combinations thereof.

3. Oral products according to claim 2, wherein said interproximal devices are selected from the group consisting of: dental flosses, dental tapes, dental flossers, dental picks, dental stimulators, proxy brushes and combinations thereof.

4. Oral products according to claim 2, wherein said confectioneries are selected from the group consisting of: mints, lozenges, dragee coated chewing gums, dragee coated bubble gums, and combinations thereof.

5. Oral products according to claim 2 wherein absorbable volatile flavors are supplied by a reservoir in a flavor-sealed environment provided with an inert volatile flavor stabilizing gas.

6. Oral products having at least one saliva soluble coating containing a flavor adsorbing substance are post-treated with absorbable, stable, volatile flavors, under flavor-sealed conditions, that promote absorption of said volatile flavors, such that during use said oral products release flavor signals imparting a cleaning perception.

7. A method for coating oral products according to claim 1, with multiple coatings of saliva soluble emulsions and sialagogues, comprising:
(a) introducing said oral products into a moving coating drum that imparts tumbling motion to said oral products,
(b) introducing, periodically into a drum, said emulsions and sialagogues,
(c) coating said moving oral products with coatings of said sialagogues and emulsions,
(d) removing substantially all the moisture between coatings, and
(e) discharging said coated oral products from said coating drum, at such time as said coating comprises from between about 0.25 and about 6% by weight of said coated oral products.

8. An apparatus useful for coating oral products with multiple saliva soluble coatings that includes: (a) a coating drum arrangement, which preferably rotates around an axis, while keeping oral products introduced into said drum in motion, (b) a means for periodically introducing a coating emulsion into said drum at a controllable rate, and (c) controllable heat and air flow means for removing moisture from coated oral products as they are tumbled in said coating drum.

9. A method for coating oral products with emulsions comprising: introducing said oral products into a coating vessel that imparts motion to said products, periodically introducing said emulsions into said coating vessel, and removing moisture from said vessel between coating applications with the introduction of controllable heat and air flow.

10. A method according to claim 7, wherein said emulsion contains a surfactant selected from the group consisting of solid and liquid surfactants and mixtures thereof.

11. A method according to claim 10, wherein said emulsion contains a polydimethylsiloxane.

12. A method according to claim 10, wherein said emulsion contains a film former.

13. A method according to claim 7, wherein said oral products are selected from the group of one-handed dental devices consisting of dental flossers, dental picks, proxy brushes and combinations thereof.

14. A method according to claim 7, wherein said coatings are selected from the group consisting of film-forming substances; emulsions; sialagogue-containing surfactant polydimethylsiloxane emulsions; saliva soluble sialagogue coatings; saliva soluble, sialagogue, crystal-free coatings; waxes; diglycerol polyphosphates; hydroxyalkyl cellulose film formers; and mixtures thereof.

15. A method according to claim 14, wherein said coatings contain additional adjuvants selected from the group consisting of sweetening agents, stabilizers, buffering ingredients, SOFT ABRASIVES®, chemotherapeutic ingredients, crystal formation eliminating additives, flavoring agents, colorants, and mixtures thereof.

16. Emulsion and sialagogue coated oral products produced by adapting confectionery coating processes, including:
(a) introducing said oral products into a moving coating drum that imparts tumbling motion to said dental devices,
(b) introducing, periodically into said drum, said emulsion and sialagogue,
(c) coating said moving oral products with multiple coatings of said sialagogue and emulsion mixture,
(d) removing substantially all the moisture between coatings, and
(e) discharging said coated oral products from said coating drum, at such time as said coating comprises from between about 0.25 and about 6% by weight of said coated oral products.

17. A method for coating disposable, one-handed dental devices with multiple coatings of saliva soluble, emulsions selected from the group of adapted methods for coating confectioneries consisting of pan coating, fluidized bed, wurster machine coating, dragee kettle coating, dragee perforated pan coating, and combinations thereof.

18. A method according to claim 7, wherein the sialagogue in said saliva soluble emulsion and sialagogue mixture is selected from the group consisting of gustatory sialagogues, pharmaceutical sialagogues, and mixtures thereof.

19. A method according to claim 7, wherein said sialagogue is selected from the group consisting of: plant extracts, Jamba Oleorisin/Spilanthol mixture, Spilanthes, Heliopsis longipes, and mixtures thereof.

20. A method according to claim 7, wherein the surfactants in said emulsions are selected from the group of liquid and solid surfactants consisting of:
polyoxyethylene glycol sorbitan mono- and di-aliphatic esters represented by the general formula: 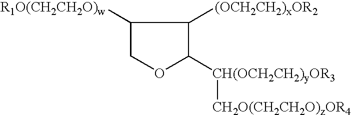
wherein R₁, R₂, R₃, R₄ and H or aliphatic acyl groups having from between about 10 and 30 carbon atoms, and the sum of w, x, y, and z is from between about 20 and about 80,
sodium lauryl sulfate,
sodium lauryl sarcosinate,
polyethylene glycol stearate,
polyethylene glycol monostearate,
coconut monoglyceride sulfonates,
sodium alkyl sulfate,
sodium alkyl sulfoacetates,
block copolymers of polyoxyethylene and polyoxybutylene,
allylpolyglycol ether carboxylates,
polyethylene derivatives of sorbitan esters,
propoxylated cetyl alcohol,
block copolymers comprising a cogeneric mixtures of conjugated polyoxypropylene, and polyoxyethylene compound having as a hydrophobe a polyoxypropylene polymer of at least 1200 molecular weight as Poloxamer 407 and Poloxamer 388,
soap powder, and
mixtures thereof.

21. Oral products according to claim 5, wherein said flavor reservoir is selected from the group consisting of absorbent paper, absorbent polymers, alcoholic solutions, and combinations thereof containing a flavor.
